(19) United States
(12) Patent Application Publication
(10) Pub. No.: US 2025/0121458 A1
(43) Pub. Date: Apr. 17, 2025

(54) SENSOR-GUIDED ADAPTIVE LASER ABLATION OF BATTERY ELECTRODES

(71) Applicant: Alliance for Sustainable Energy, LLC, Golden, CO (US)

(72) Inventors: Donal Patrick FINEGAN, Lakewood, CO (US); Francios Laurent Emilien USSEGLIO VIRETTA, Lakewood, CO (US); Dana Birute KERN, Golden, CO (US); Bertrand Jean-François TREMOLET DE VILLERS, Golden, CO (US)

(21) Appl. No.: 18/918,294

(22) Filed: Oct. 17, 2024

Related U.S. Application Data
(60) Provisional application No. 63/590,839, filed on Oct. 17, 2023.

(51) Int. Cl. B23K 26/362; B23K 26/03; B23K 26/0622; B23K 26/16; B23K 101/36; H01M 4/04

(52) U.S. Cl. CPC B23K 26/362; B23K 26/032; B23K 26/0622; B23K 26/16; H01M 4/0471; B23K 2101/36

(57) ABSTRACT

Methods and systems for processing battery electrodes are disclosed. A system for processing battery electrodes includes a first measurement device for measuring one or more parameters of a target region of a battery electrode; a pulsed laser system for removing a portion of the target region of a sample of material comprising battery electrodes based one or more measured parameters as measured by the first measurement device; a control system for controlling the removing that is in communication with the first measurement device and the laser system; and a debris collection device for removing debris from the target region.

### CROSS-REFERENCE TO RELATED APPLICATIONS

This application claims priority to U.S. Patent Application Provisional Ser. No. 63/590,839 filed on Oct. 17, 2023, the contents of which are hereby incorporated by reference in its entirety.

### GOVERNMENT RIGHTS

This invention was made with United States government support under Contract No. DE-AC36-08GO28308 awarded by the U.S. Department of Energy. The United States government has certain rights in this invention.

### BACKGROUND

Lithium-ion batteries are increasingly used for compact applications, such as wireless car pods, and compact medical devices, such as pacemakers. These designs require battery electrodes to be wound up into very small spaces, limiting the thickness of electrodes due to cracking and delamination when the electrodes bend around the small radius of curvature. During cycling of lithium-ion batteries, lithium ions must homogenously lithiate particles throughout all depths of the electrode in the battery. The ionic conductivity, or case for lithium ions to travel through a medium, of electrolyte limits how quickly lithium can travel to and from electrodes during cycling. However, it is very challenging to manufacture thick electrodes because minimizing heterogeneity in the electrode becomes more challenging with increasing thickness. Thick electrodes are also inhibited by poor rate capability (i.e., not being able to charge quickly). Thus, there remains a need for a means of controlling electrode thickness by reducing heterogeneity through corrective action.

### SUMMARY

According to examples of the present disclosure, a method for improved laser ablation of a lithium-ion battery is disclosed. The method comprises using a measurement device, such as but not limited to a profilometer, to determine an adjusted focal depth; and performing laser ablation with a focal point at the adjusted focal depth on the lithium-ion battery. Various additional features can be included in the method such as one or more of the following features. The method can further comprise collecting a waste from the lithium-ion battery after the performing. The measurement device can be in communication with a laser and the laser can be configured to perform the performing. The method can further comprise using the laser to perform current collector roughening. The lithium-ion battery material can have a thickness of approximately 300 μm during the using and the lithium-ion battery material can have a thickness of less than approximately 300 μm after the performing.

According to examples of the present disclosure, a system for improved laser ablation of a lithium-ion battery is disclosed. The system comprises a measurement device, such as but not limited to a profilometer and a laser; wherein the laser is configured to perform laser ablation on the lithium-ion battery. Various additional features can be included in the system such as one or more of the following features. The system can further comprise a cyclonic debris collector configured to collect a waste from the lithium-ion battery after laser ablation is performed. The laser can be configured to perform current collector roughening. The lithium-ion battery material can have a thickness of approximately 300 μm and the laser ablation is configured to reduce the thickness of the lithium-ion battery material to less than approximately 300 μm. The profilometer measurement device can be in communication with the laser.

According to examples of the present disclosure, a method for processing battery electrodes is disclosed. The method comprises measuring one or more first parameters of a target region of a sample of material comprising battery electrodes using a first measurement device; removing one or more edges of the target region of each individual battery electrodes of the battery using a pulsed laser system that is scanned across a width based one or more measured parameters as measured by the one or more measuring devices; performing a removal of the one or more edges that were removed by the pulsed laser system using a control system that is in communication with the first measurement device and the pulsed laser system or controlling the removing using a control system that is in communication with the first measurement device and the pulsed laser system; and removing debris from the target region using a debris collection device. Various additional features can be included in the method such as one or more of the following features. The sample with the battery electrodes can be processed on a continuous roll of material or on individual sheets of material in a batch process. The method can further comprise measuring one or more second parameters of the target region of the sample of material using a second measurement device after the one or more edges of the target region are removed by the pulsed laser system. The one or more first parameters, the one or more second parameters, or both comprise a width of the sample, a surface thickness, a surface roughness, or combinations thereof. The first measurement device, the second measurement device, or both can comprise an optical-based system, an ionizing radiation-based system, a non-ionizing radiation-based system, a weight-based system, or combinations thereof. The optical-based system can include a measurement device, such as but not limited to a profilometer. The first measurement device, the second measurement device, or both can comprise a detector. The first measurement device, the second measurement device, or both can comprise a time-based device that can flash or pulse a laser against a surface, such as the sample, and measure the time between the flash and the reflected light reaching a detector. The weight-based system can measure the local weights of coatings on the sample. The performing can comprise adjusting one or more laser parameters of the pulsed laser system based on measurements by the first measurement device, the second measurement device, or both. The one or more laser parameters can comprise a focal length, a focal depth, a pulse duration, a pulse frequency, a power intensity, a spot diameter, a fluence, or combinations thereof. The one or more first parameters and the one or more second parameters can be the same or different. The sample can be a continuous roll of material. The debris that is removed by the debris collection device can be used for potential reuse and/or recycling.

According to examples of the present disclosure, a method for processing battery electrodes is disclosed. The method comprises measuring one or more first parameters of a target region of a sample of material comprising battery electrodes using a first measurement device; removing a portion of a top surface of the target region to a predetermined thickness of each individual battery electrode of the battery using a pulsed laser system that is scanned across a width based one or more measured parameters as measured by the one or more measuring devices; performing a removal of the portion of the top surface using a control system that is in communication with the first measurement device and the pulsed laser system or controlling the removing using a control system that is in communication with the first measurement device and the pulsed laser system; and removing debris from the target region using a debris collection device. Various additional features can be included in the method such as one or more of the following features. The sample with the battery electrodes can be processed on a continuous roll of material or on individual sheets of material in a batch process. The method can further comprise measuring one or more second parameters of the target region of the sample of material using a second measurement device after the portion of the top surface is removed by the pulsed laser system. The one or more first parameters, the one or more second parameters, or both can comprise a width, a surface thickness, a surface roughness, or combinations thereof. The surface thickness can be about 5 μm to about 1000 μm. The first measurement device, the second measurement device, or both can comprise an optical-based system, an ionizing radiation-based system, a non-ionizing radiation-based system, a weight-based system, or combinations thereof. The optical-based system can include a profilometer. The first measurement device, the second measurement device, or both can comprise a detector. The first measurement device, the second measurement device, or both can comprise a time-based device that can flash or pulse a laser against a surface, such as the sample, and measure the time between the flash and the reflected light reaching a detector. The weight-based system can measure the local weights of coatings on the sample. The performing can comprise adjusting one or more laser parameters of the pulsed laser system based on measurements by the first measurement device, the second measurement device, or both. The one or more laser parameters can comprise a focal length, a focal depth, a pulse duration, a pulse frequency, a power intensity, a spot diameter, a fluence, or combinations thereof. The one or more first parameters and the one or more second parameters can be the same or different. The sample can be a continuous roll of material or on individual sheets of material in a batch process. The debris that is removed by the debris collection device can be used for potential reuse and/or recycling.

According to examples of the present disclosure, a method for processing battery electrodes is disclosed. The method comprises measuring one or more first parameters of a target region of a sample of material comprising battery electrodes using a first measurement device; correcting one or more geometric features of the target region of each individual battery electrode of the battery using a pulsed laser system that is scanned across a width based one or more measured parameters as measured by the one or more measuring devices; performing a geometric feature correction that was corrected using the pulsed laser system using a control system that is in communication with the first measurement device and the pulsed laser system; and removing debris from the target region using a debris collection device. Various additional features can be included in the method such as one or more of the following features. The sample with the battery electrodes can be processed on a continuous roll of material or on individual sheets of material in a batch process. The method can further comprise measuring one or more second parameters of the target region of the sample of material using a second measurement device after the correcting by the pulsed laser system. The one or more first parameters, the one or more second parameters, or both can comprise a width of the sample, a surface thickness, a surface roughness, or combinations thereof. The first measurement device, the second measurement device, or both can comprise an optical-based system, an ionizing radiation-based system, a non-ionizing radiation-based system, a weight-based system, or combinations thereof. The optical-based system can include a profilometer. The first measurement device, the second measurement device, or both can comprise a detector. The first measurement device, the second measurement device, or both can comprise a time-based device that can flash or pulse a laser against a surface, such as the sample, and measure the time between the flash and the reflected light reaching a detector. The weight-based system can measure the local weights of coatings on the sample. The performing can comprises adjusting one or more laser parameters of the pulsed laser system based on measurements by the first measurement device, the second measurement device, or both. The one or more laser parameters comprise a focal length, a focal depth, a pulse duration, a pulse frequency, a power intensity, a spot diameter, a fluence, or combinations thereof. The one or more geometric features can comprise one or more predetermined sized and spaced apertures in the battery electrodes that can increase energy storage density, power density, or cycle life. The one or more first parameters and the one or more second parameters can be the same or different. The sample can be a continuous roll of material. The debris that is removed by the debris collection device can be used for potential reuse and/or recycling.

According to examples of the present disclosure, a system for processing battery electrodes is disclosed. The system comprises a first measurement device for measuring one or more parameters of a target region of a battery electrode; a pulsed laser system for removing a portion of the target region of a sample of material comprising battery electrodes based one or more measured parameters as measured by the first measurement device; a control system for controlling the removing that is in communication with the first measurement device and the laser system; and a debris collection device for removing debris from the target region. Various additional features can be included in the system such as one or more of the following features. The sample with the battery electrodes can be processed on a continuous roll of material or on individual sheets of material in a batch process. The system can further comprise a second measurement device for measuring one or more second parameters of the target region after the removing by the pulsed laser system. The one or more first parameters, the one or more second parameters, or both can comprise a width of the sample, a surface thickness, a surface roughness, or combinations thereof. The surface thickness is about 5 μm to about 1000 μm. The first measurement device, the second measurement device, or both can comprise an optical-based system, an ionizing radiation-based system, a non-ionizing radiation-based system, a weight-based system, or combinations thereof. The first measurement device, the second measurement device, or both can comprise a detector. The first measurement device, the second measurement device, or both can comprise a time-based device that can flash or pulse a laser against a surface, such as the sample, and measure the time between the flash and the reflected light reaching a detector. The weight-based system can measure the local weights of coatings on the sample. The control system can adjust one or more laser parameters of the pulsed laser system based on measurements of the first measurement device, the second measurement device, or both. The one or more laser parameters can comprise a focal length, a focal depth, a pulse duration, a pulse frequency, a power intensity, a spot diameter, a fluence, or combinations thereof. The portion of the target region can comprise a current collector region that is roughened by the pulsed laser system. The one or more first parameters and the one or more second parameters can be the same or different. The sample can be a continuous roll of material. The debris that is removed by the debris collection device can be used for potential reuse and/or recycling.

### BRIEF DESCRIPTION OF THE DRAWINGS

Some examples of the present disclosure are illustrated in the referenced figures of the drawings. It is intended that the examples and figures disclosed herein are to be considered illustrative rather than limiting.

FIG. 1 shows a generalized block depicted system for processing battery electrodes according to examples of the present disclosure.

FIG. 2 shows an example system that depicts a first measurement device as a profilometer in communication with a first pulsed laser according to examples of the present disclosure.

FIG. 3 shows an example system that depicts a first pulsed laser, a second pulsed laser, and a debris collection device according to examples of the present disclosure.

FIG. 4 shows an example system that depicts a first pulsed laser providing current collector roughening and enhanced adhesion according to examples of the present disclosure.

FIG. 5 shows an example system operating in a first scanning mode according to examples of the present disclosure.

FIG. 6 shows an example system operating in a second scanning mode that includes beam splitting with 1-axis servo according to examples of the present disclosure.

FIG. 7 shows an example system operating in a third scanning mode that includes a 2-axis galvanometer scan head according to examples of the present disclosure.

FIG. 8A shows a side depiction of system for processing battery electrodes according to examples of the present disclosure. FIG. 8B shows another view of the system in FIG. 8A.

FIGS. 8C and 8D show different sizes for the geometric features at different zoom magnifications, respectively, on a sample that is produced by a laser according to examples of the present disclosure.

FIG. 8E shows two different example features according to examples of the present disclosure.

FIG. 9 shows different geometric features produced by a laser on different sample materials according to examples of the present disclosure.

FIG. 10 shows a graphical representation of different geometric features produced by a laser on different sample materials showing a depth of penetration in the sample material according to examples of the present disclosure.

FIGS. 11A, 11B, 11C, 11D, 11E, and 11F show plots of different laser parameters for different lasers on different sample materials that can be used in the processes described herein according to examples of the present disclosure.

FIG. 12 shows flowchart for a method for processing battery electrodes according to examples of the present disclosure

FIG. 13 shows flowchart for a method for processing battery electrodes according to examples of the present disclosure.

FIG. 14 shows flowchart for a method for processing battery electrodes according to examples of the present disclosure.

### DETAILED DESCRIPTION

The examples described herein should not necessarily be construed as limited to addressing any of the particular problems or deficiencies discussed herein. References in the specification to “one example”, “an example”, “an example embodiment”, “some examples”, etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some examples of the present disclosure, the term “substantially” is defined as approaching a specific numeric value or target to within 20%, 15%, 10%, 5%, or within 1% of the value or target. In further examples of the present disclosure, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some examples of the present disclosure, the term “about” is used to indicate an uncertainty limit of less than or equal to ±20%, ±15%, ±10%, ±5%, or ±1% of a specific numeric value or target. In some examples of the present disclosure, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

The present disclosure relates to enhancing the precision of laser ablation by adapting the laser's focal length through the electrode thickness to allow for selective removal of material for better thickness uniformity. The methods described herein include using profilometry data to tailor corrective action taken by a laser to homogenize electrode thickness and achieve better control of electrode physical properties. The methods may include profilometry-guided laser ablation, waste collection, and current collector treatment for enhanced adhesion.

In some examples, a profilometry technique may be used for validating the depth and dimensions of ablated features in lithium-ion battery samples. The data collected may be applied to inform laser-ablation conditions, particularly as an in-line technique. An electrode (for example, an electrode having a thickness in the range of about 300 μm to about 310 μm) may be analyzed, which involves collecting data about the thickness heterogeneity data from profilometry. This data may be used in the laser ablation computer aided design (CAD) software with instructions to smooth the electrode to a minimum thickness (about 300 μm) using ablation. In some examples, the methods described herein may result in the thickness range of an electrode (i.e., the difference between the maximum thickness and minimum thickness of the electrode) to less than 10% of its original value. In some examples, by reading an electrode's thickness data using profilometry (for example, an electrode having a thickness of about 300 μm) may be used to guide the laser's focal length for precise material removal through the thickness of the electrode (for the example electrode, 300 μm).

Laser ablation of lithium-ion battery electrodes to precisely control electrode microstructures and/or electrode properties is a promising technique for improving battery performance. Laser ablation can be incorporated into production lines, for example, onto continuously moving roll-to-roll (also known as jelly roll) assemblies where rolls of foil are coated with a slurry of electrode material, dried, and calendared (i.e., compressed) before being assembled into a battery. The present disclosure encompasses a sensor-guided laser ablation system where sensor data such as X-ray inspection, laser, or optical techniques that can monitor electrode coatings for defects or heterogeneous conditions like thicknesses or composition, is used to enable adaptive laser-ablation. Data measured from upstream sensor technology (such as absolute values of coating thickness, variations in coating thickness, or the presence of defects) is used by the laser system to adapt to local coating conditions. For example, for an electrode coating having a thickness greater than about 200 μm (also known as an ultrathick electrode coating), the focal length of the laser may need to be adjusted as it ablates deeper into the electrode. The thickness data may inform the laser of how much the focal length may need to be adjusted, how many laser pulses, and the power of such laser pulses may be required for ablating deep trenches. In some examples, corrective action may be taken, when the sensor detects thickness variations in the electrode coating, then the laser may use this data to correct such variations and remove localized electrode material and make the electrode coating thickness more uniform. In some examples, thicker electrode regions may be structured with thicker channels, creating channel heterogeneity to counter coating thickness heterogeneity in order to uniformize effective ionic transport in the whole electrode. Heterogeneous channels may also be applied to limit degradations mechanism induced by form factor/edge effects. The present disclosure encompasses the technology of a combined sensor-laser system for adaptive-laser ablation on roll-to-roll production lines of lithium-ion electrodes.

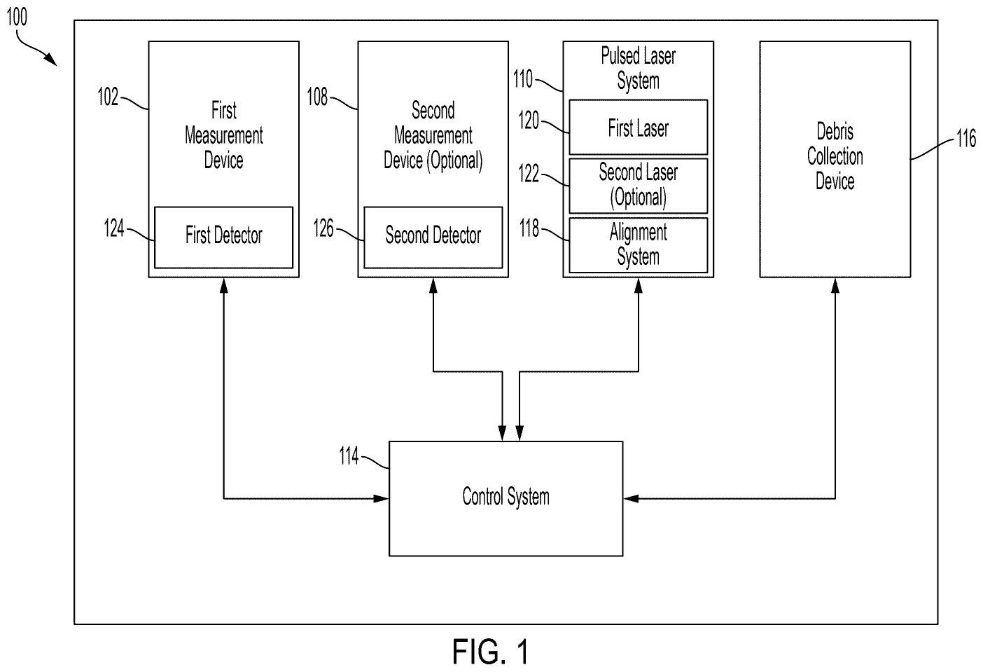

FIG. 1 shows generalized block depicted system 100 for processing battery electrodes according to examples of the present disclosure. System 100 comprises first measurement device 102 for measuring one or more parameters of target region 104 of battery electrode 106. First measurement device 102 can comprise an optical-based system, an ionizing radiation-based system, a non-ionizing radiation-based system, a weight-based system, or combinations thereof. The optical-based system can comprise a profilometer. The one or more parameters comprise a surface thickness, a surface roughness, or combinations thereof. The surface thickness can be between about 5 μm to about 1000 μm, for example about 300 μm. The battery can be a lithium-ion battery and can have a thickness between about 5 μm to about 1000 μm, for example about 300 μm and the laser ablation is configured to reduce the thickness of the lithium-ion battery between about 5 μm to about 1000 μm, for example about less or equal to approximately 300 μm.

System 100 can optionally further comprise second measurement device 108 for measuring one or more second parameters of target region 104 after the removing by pulsed laser system 110. Second measurement device 108 can comprise an optical-based system, an ionizing radiation-based system, a non-ionizing radiation-based system, a weight-based system, or combinations thereof. The optical-based system can comprise a profilometer. First measurement device 102 and second measurement device 108 can be the same or different measurement devices that measure the same or different parameters of target region 104. First measurement device 102, second measurement device 108, or both can comprise a detector, such as first detector 124 and second detector 126, respectively. First measurement device 102, second measurement device 108, or both can comprise a time-based device that can flash or pulse a laser, such as first pulsed laser 120, second pulsed laser 122, or both against a surface, such as the sample, and measure the time between the flash and the reflected light reaching a detector. The weight-based system can measure the local weights of coatings on the sample.

System 100 also comprises pulsed laser system 110 for removing a portion of target region 204 of sample 206 continuous roll of material comprising battery electrodes based one or more measured parameters as measured by first measurement device 102. For example, pulsed laser system 110 can be configured to perform current collector roughening. Pulsed laser system 110 can comprise first pulsed laser 120 and optionally second pulsed laser 122. Pulsed laser system 110 can also comprise alignment system 118 that can include one or more alignment and/or translation optics and/or one or more beam conditioning optics that adjusts, moves, and/or conditions the laser beam produced by first pulsed laser 120 and/or second pulsed laser 122.

System 100 also comprises control system 114 for controlling the removing that is in communication with the first measurement device and the laser system. Control system 114 can be configured to communicate with first measurement device 102, second measurement device 108, or both. Control system 114 can be arranged as a feedback, a feedforward, or both a feedback and a feedforward system based on measurements made by first measurement device 102, second measurement device 108, or both. Control system 114 can be configured to adjust one or more laser parameters of the pulsed laser system based on measurements of first measurement device 102, second measurement device 108, or both. The one or more laser parameters comprise a focal length, a focal depth, a pulse duration, a pulse frequency, a power intensity, a spot diameter, a fluence, or combinations thereof.

System 100 also comprises debris collection device 116 for removing debris from target region 104. For example, debris collection device 116 can comprise a cyclonic debris collector that is configured to collect a waste from the lithium-ion battery after laser ablation is performed. The portion of target region 104 can comprise a current collector region that is roughened by pulsed laser system 110. The debris that is removed by debris collection device 116 can be used for potential reuse and/or recycling.

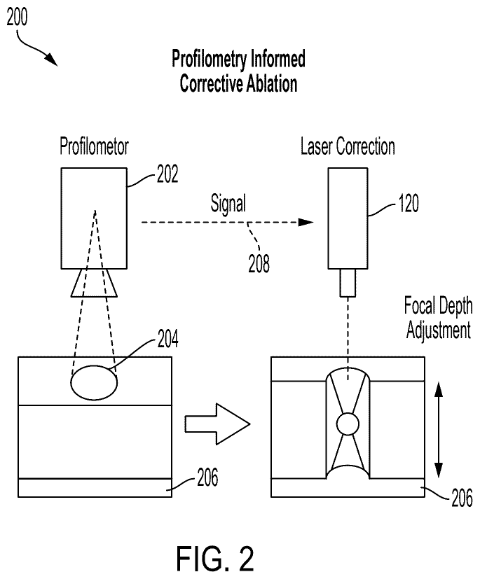

FIG. 2 shows an example system 200 that depicts first measurement device 102 as profilometer 202 in communication with first pulsed laser 120 according to examples of the present disclosure. Profilometer 202 measures one or more first parameters of target region 204 of sample 206, such as a continuous roll of material or individual sheets of material, that contains material from which battery electrodes are produced. Profilometer 202, in communication with first pulsed laser 120, provides signal 208 to first pulsed laser 120 to provide laser correction by maintaining, if no adjustments in the one more laser parameters are needed as measured by profilometer 202, the one or more laser parameters of first pulsed laser 120 or adjusting, if adjustments are needed as measured by profilometer 202, one or more laser parameters of first pulsed laser 120. Although not shown in FIG. 2, signal 208 can be provided to control system 114, which then provides the signal 208 to first pulsed laser 120 for adjustment, if necessary. As shown in the example of FIG. 2, the focal depth of first pulsed laser 120 is the laser parameter that is adjusted. However, other laser parameters can be adjusted such as a focal length, a focal depth, a pulse duration, a pulse frequency, a power intensity, a spot diameter, a fluence, or combinations thereof.

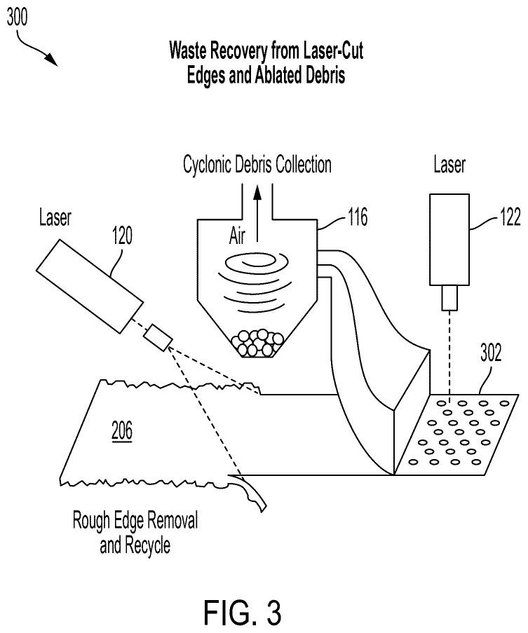

FIG. 3 shows an example system 300 that depicts first pulsed laser 120, second pulsed laser 122, and debris collection device 116 according to examples of the present disclosure. First pulsed laser 120 is shown removing rough edges of sample 206 and second pulsed laser 122 is shown etching/correcting geometric features 302 in sample 206. Geometric features 302 can include one or more predetermined sized and spaced apertures in the battery electrodes that can improve battery characteristics of the electrodes of the battery, such as increase energy storage density, power density, or cycle life, by, for example, providing current collector roughening and enhanced adhesion. Debris collection device 116, in the form of a cyclonic debris collection device, is arranged to collect and remove debris created by operation of first pulsed laser 120 and/or second pulsed laser 122.

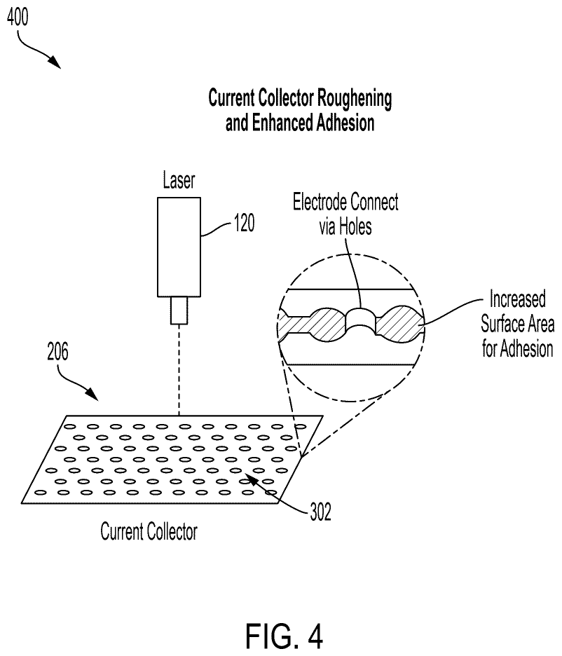

FIG. 4 shows an example system 400 that depicts first pulsed laser 120 providing current collector roughening and enhanced adhesion according to examples of the present disclosure. First pulsed laser 120 is shown providing current collector roughening, enhanced adhesion, and etching/correcting geometric features 302 in sample 206. Geometric features 302 can include one or more predetermined sized and spaced apertures in the battery electrodes that can improve battery characteristics of the electrodes of the battery, such as increase energy storage density, power density, or cycle life, by, for example, providing current collector roughening and enhanced adhesion.

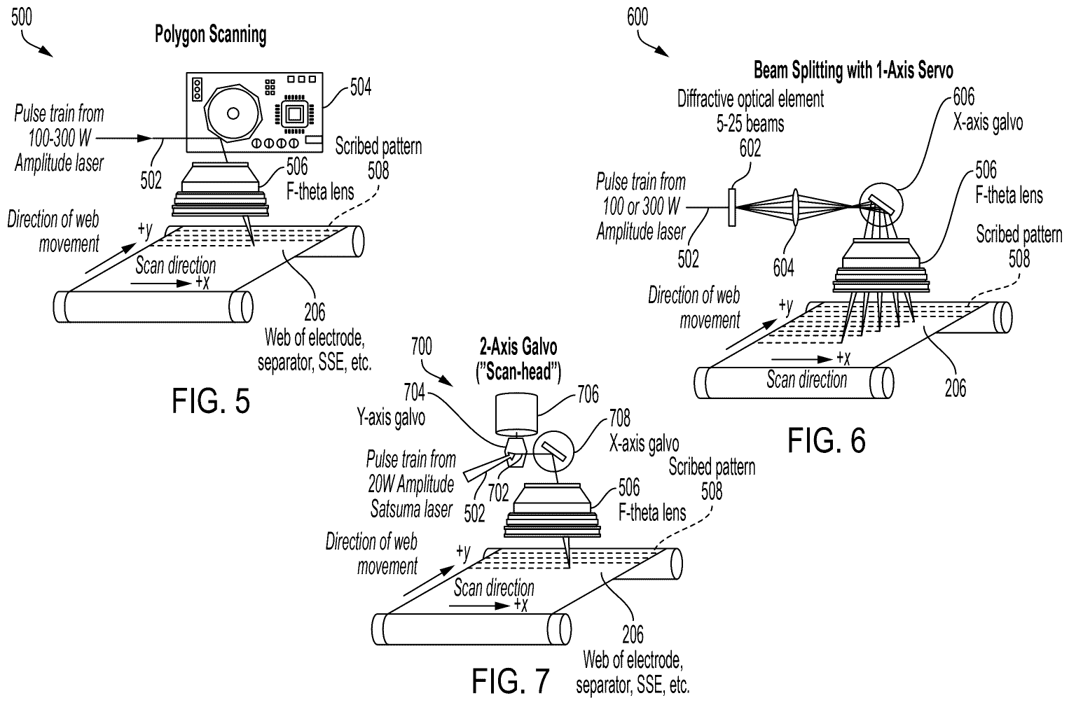

FIG. 5 shows an example system 500 operating in a first scanning mode according to examples of the present disclosure. As shown in FIG. 5, laser beam 502 from first pulsed laser 112 is directed to polygon scanner 504 and F-theta lens 506 of alignment system 118, which is then directed onto a surface of sample 206. In the example of FIG. 5, sample 206 is a web of electrode material that is moved by rollers in the direction of web movement as indicated by the associated arrow in FIG. 5. Laser beam 502 is scanned across the surface of sample 206 in scan direction as indicated by the associated arrow in FIG. 5 to produce scribed pattern 508 in a polygon scanning operation.

FIG. 6 shows an example system 600 operating in a second scanning mode that includes beam splitting with 1-axis servo according to examples of the present disclosure. As shown in FIG. 6, laser beam 502 from first pulsed laser 112 is directed to diffraction element 504, focusing optical element 604, x-axis galvanometer 606, and F-theta lens 506 of alignment system 118, which is then directed onto a surface of sample 206. In the example of FIG. 6, sample 206 is a web of electrode material that is moved by rollers in the direction of web movement as indicated by the associated arrow in FIG. 6. Laser beam 502 is scanned across the surface of sample 206 in scan direction as indicated by the associated arrow in FIG. 6 to produce scribed pattern 508 in a scanning operation.

FIG. 7 shows an example system 700 operating in a third scanning mode that includes a 2-axis galvanometer scan head according to examples of the present disclosure. As shown in FIG. 7, laser beam 502 from first pulsed laser 112 is directed to first optically transmissive element 702 that is actuated by y-axis galvanometer 704 and second optically reflective element that is actuated by x-axis galvanometer 708, and F-theta lens 506 of alignment system 118, which is then directed onto a surface of sample 206. In the example of FIG. 7, sample 206 is a web of electrode material that is moved by rollers in the direction of web movement as indicated by the associated arrow in FIG. 7. Laser beam 502 is scanned across the surface of sample 206 in scan direction as indicated by the associated arrow in FIG. 7 to produce scribed pattern 508 in a scanning operation.

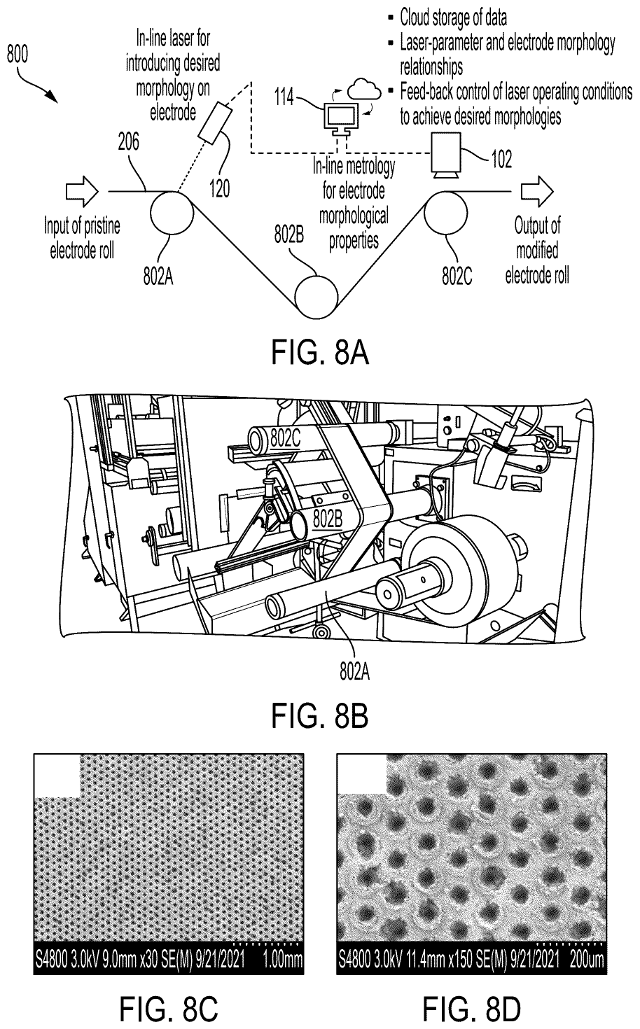

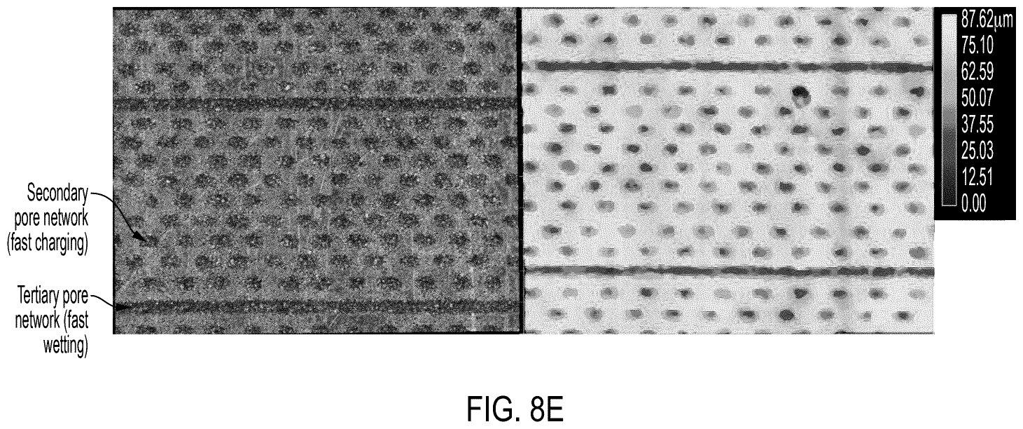

FIG. 8A shows a side depiction of system 800 for processing battery electrodes according to examples of the present disclosure. FIG. 8B shows another view of system 800. Sample 206, in the form of a continuous web of material, is moved along the processing operation by rollers 802A, 802B, and 802C. In this example, first pulsed laser 112 is configured to introduce a desired morphology on the electrode on the surface of sample 206 and first measurement device 102 measures one or more electrode morphological properties of the electrode. First measurement device 102 can comprise an optical-based system, an ionizing radiation-based system, a non-ionizing radiation-based system, a weight-based system, or combinations thereof. The optical-based system can include a profilometer. First measurement device 102 can comprise a detector and can comprise a time-based device that can flash or pulse a laser against a surface, such as the sample, and measure the time between the flash and the reflected light reaching a detector. The weight-based system can measure the local weights of coatings on the sample. Control system 114 is in electrical and data communication with first pulsed laser 112 and first measurement device 102 to provide control signals to each and to received measurement data from first measurement device 102 to adjust one or more laser parameters of first pulsed laser 112. The one or more laser parameters can comprise a focal length, a focal depth, a pulse duration, a pulse frequency, a power intensity, a spot diameter, a fluence, or combinations thereof. The morphology can include a width, a surface thickness, a surface roughness, one or more geometric features, or combinations thereof, that can comprise one or more predetermined sized and spaced apertures in the battery electrodes that can increase energy storage density, power density, or cycle life.

FIGS. 8C and 8D show different sizes for the geometric features at different magnification levels, respectively, on a sample that is produced by a laser according to examples of the present disclosure. In FIG. 8C, the geometric features are smaller and in FIG. 8D the geometric features are larger in diameter. The geometric features can be used to increase energy storage density, power density, or cycle life of the battery.

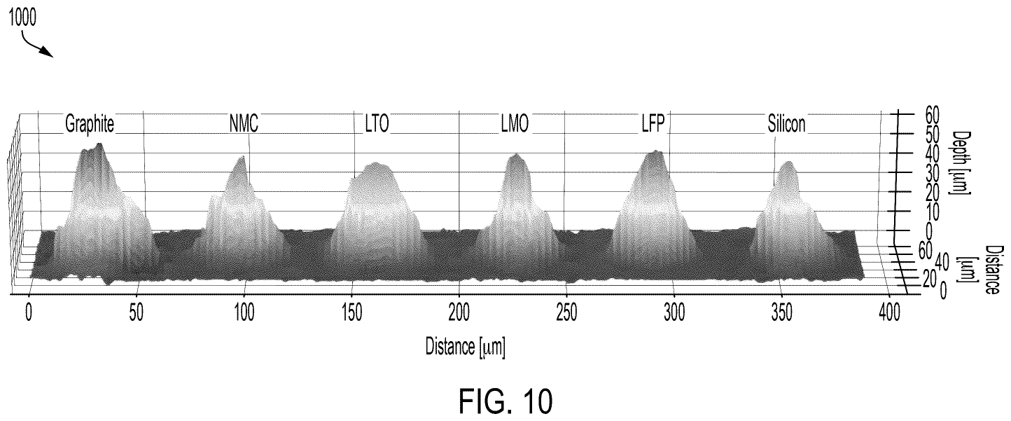

FIG. 8E shows two different example features according to examples of the present disclosure. The first example feature are cone-like microstructures (c.f. FIG. 10) that extend approximately half the thickness of the electrode introduce a secondary porosity (secondary pore network) that reduces the tortuosity of lithium-ion transport to the electrode active materials, thus improving charging rate (“fast charging”). The second example feature are channel-like microstructures that have a large length to width aspect ratio, and depth approximately half the electrode thickness, usually span the width of the electrode to improve wetting and distribution of the liquid electrolyte with the electrode. Also, micro-channels form a tertiary pore network when combined with the pore-like features.

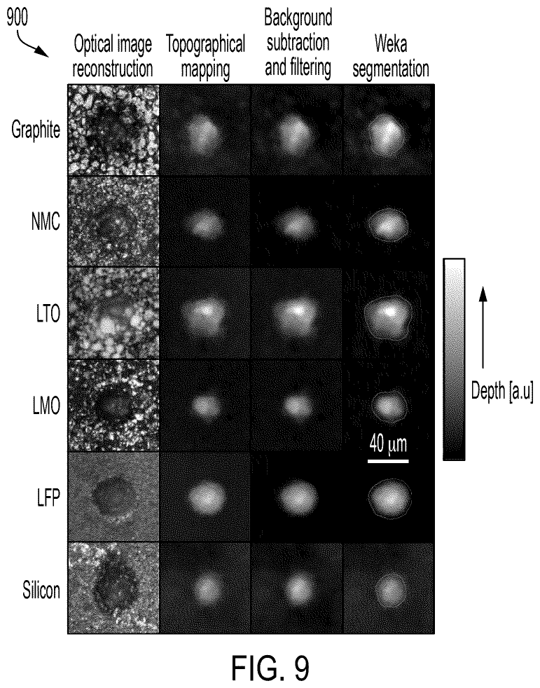

FIG. 9 shows different geometric features produced by a laser on different sample materials according to examples of the present disclosure.

FIG. 10 shows a graphical representation of different geometric features produced by a laser on different sample materials showing a depth of penetration in the sample material according to examples of the present disclosure. As shown, the graphical representations represent data from a measurement device, and in this example, data from a profilometer that visually shows spatially recorded data on the depth of the laser-ablated features.

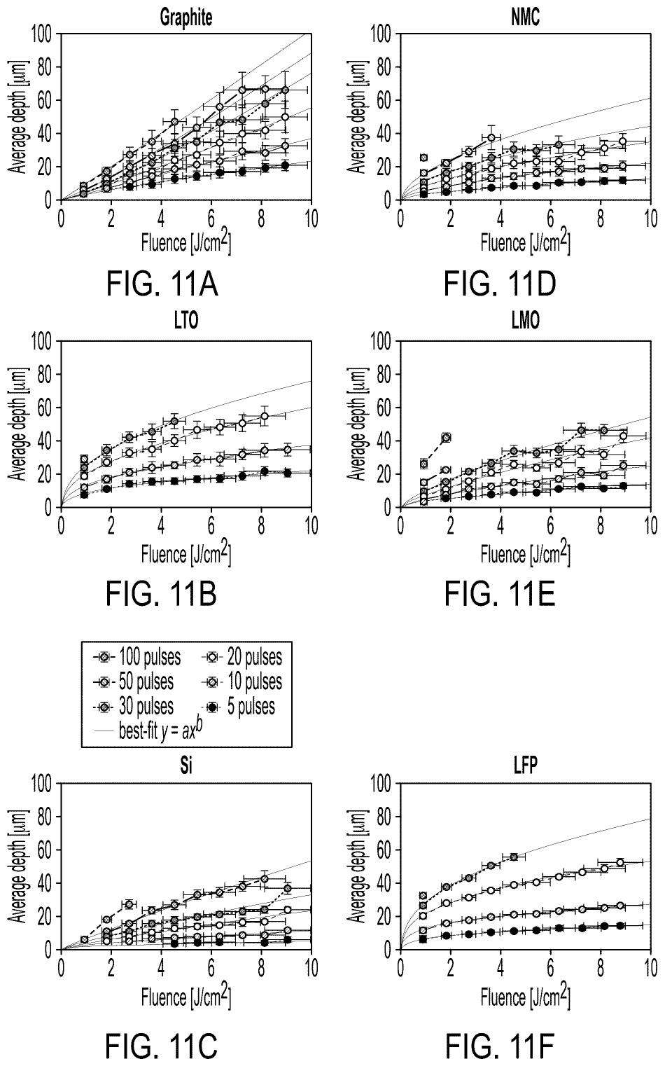

FIGS. 11A, 11B, 11C, 11D, 11E, and 11F show plots of different laser parameters for different lasers on different sample materials that can be used in the processes described herein according to examples of the present disclosure. As shown, these plots show examples of correlations between laser process parameters and the shape of the laser ablated features in the material. They represent examples of the relationships between process conditions and outcomes that can be made using the combination of the measurement devices and the laser ablation system. The plots are from real-world data from experiments conducted by the inventors.

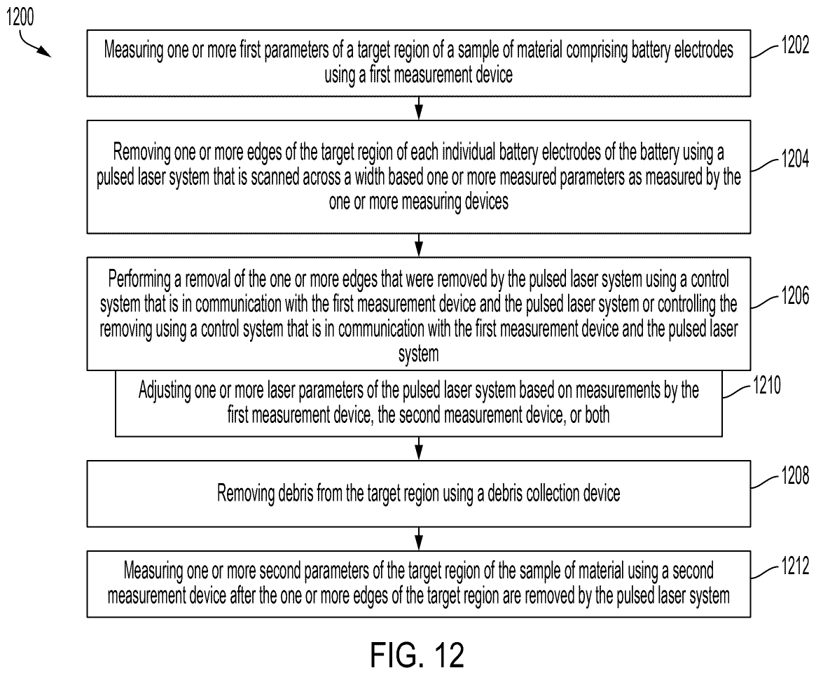

FIG. 12 shows flowchart 1200 for a method for processing battery electrodes according to examples of the present disclosure. The method begins by measuring one or more first parameters of a target region of a sample of material comprising battery electrodes using a first measurement device, as in 1202. For example, the sample with the battery electrodes can be processed on a continuous roll of material or on individual sheets of material in a batch process. For example, as shown in FIGS. 1, 2, 3, 4, 5, 6, 7, 8A, 8B, and 8C, first measurement device 102 can measure one or more first parameters of target region 204 of sample 206. First measurement device 102 can comprise an optical-based system, an ionizing radiation-based system, a non-ionizing radiation-based system, a weight-based system, or combinations thereof. The optical-based system can include a profilometer. First measurement device 102 can comprise first detector 124. First measurement device 102 can comprise a time-based device that can flash or pulse first pulsed laser 120 against a surface, such as target region 204 of sample 206, and measure the time between the flash and the reflected light reaching first detector 124. The weight-based system can measure the local weights of coatings on sample 206. The one or more first parameters can comprise a width, a surface thickness, a surface roughness, or combinations thereof, of sample 206.

The method continues by removing one or more edges of the target region of each individual battery electrodes of the battery using a pulsed laser system that is scanned across a width based one or more measured parameters as measured by the one or more measuring devices, as in 1204. As shown in FIG. 3, first pulsed laser 120 removes edges of sample 206.

The method continues by performing a removal of the one or more edges that were removed by the pulsed laser system using a control system that is in communication with the first measurement device and the pulsed laser system or controlling the removing using a control system that is in communication with the first measurement device and the pulsed laser system, as in 1206. The performing, as in 1206, can comprise adjusting one or more laser parameters of the pulsed laser system based on measurements by the first measurement device, the second measurement device, or both, as in 1210. As shown in FIGS. 1, 2, and 8A, control system 114 is in electrical and communication connection with pulsed laser system 110 and first measurement device 102 to provide feedback to both systems and to control laser parameter adjustment of first pulsed laser 120 based on measurements made by first measurement device 120. The one or more laser parameters can comprise a focal length, a focal depth, a pulse duration, a pulse frequency, a power intensity, a spot diameter, a fluence, or combinations thereof. The one or more first parameters and the one or more second parameters can be the same or different.

The method continues by removing debris from the target region using a debris collection device, as in 1208. The debris that is removed by the debris collection device can be used for potential reuse and/or recycling. As shown in FIGS. 1 and 3, debris collection device 116, such as a cyclonic debris collector, is configured to remove the debris from laser ablation processes on the battery electrodes.

The method can also include measuring one or more second parameters of the target region of the sample of material using a second measurement device after the one or more edges of the target region are removed by the pulsed laser system, as in 1212. For example, as shown in FIGS. 1, 2, 3, 4, 5, 6, 7, 8A, 8B, and 8C, second measurement device 108 can measure one or more second parameters of target region 204 of sample 206. Second measurement device 108 can comprise an optical-based system, an ionizing radiation-based system, a non-ionizing radiation-based system, a weight-based system, or combinations thereof. The optical-based system can include a profilometer. Second measurement device 108 can comprise second detector 126. Second measurement device 108 can comprise a time-based device that can flash or pulse second pulsed laser 122 against a surface, such as target region 204 of sample 206, and measure the time between the flash and the reflected light reaching second detector 126. The weight-based system can measure the local weights of coatings on sample 206. The one or more first parameters can comprise a width, a surface thickness, a surface roughness, or combinations thereof, of sample 206. The surface thickness can be about 5 μm to about 1000 μm.

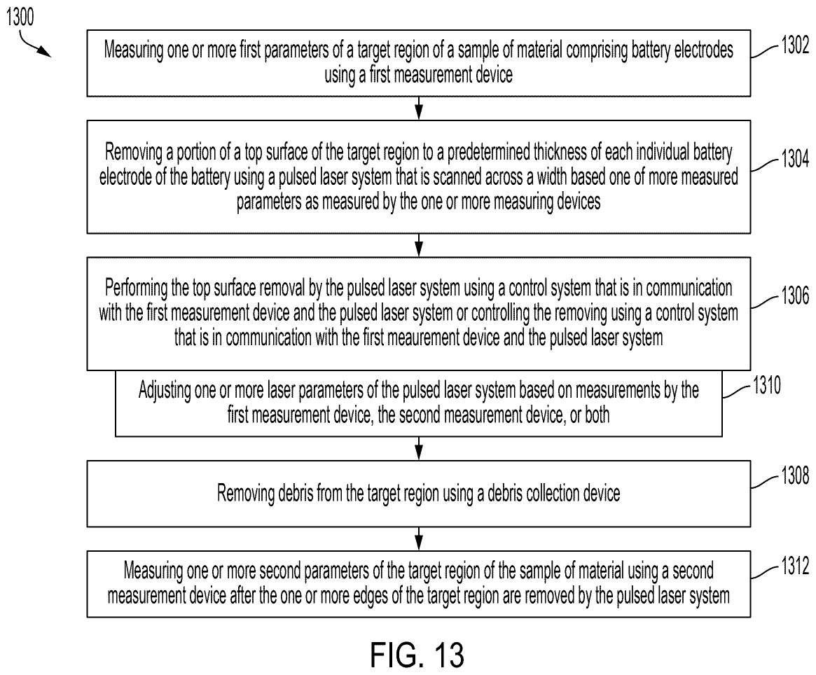

FIG. 13 shows flowchart 1300 for a method for processing battery electrodes according to examples of the present disclosure. The method begins by measuring one or more first parameters of a target region of a sample of material comprising battery electrodes using a first measurement device, as in 1302. For example, the sample with the battery electrodes can be processed on a continuous roll of material or on individual sheets of material in a batch process. For example, as shown in FIGS. 1, 2, 3, 4, 5, 6, 7, 8A, 8B, and 8C, first measurement device 102 can measure one or more first parameters of target region 204 of sample 206. First measurement device 102 can comprise an optical-based system, an ionizing radiation-based system, a non-ionizing radiation-based system, a weight-based system, or combinations thereof. The optical-based system can include a profilometer. First measurement device 102 can comprise first detector 124. First measurement device 102 can comprise a time-based device that can flash or pulse first pulsed laser 120 against a surface, such as target region 204 of sample 206, and measure the time between the flash and the reflected light reaching first detector 124. The weight-based system can measure the local weights of coatings on sample 206. The one or more first parameters can comprise a width, a surface thickness, a surface roughness, or combinations thereof, of sample 206.

The method continues by removing a portion of a top surface of the target region to a predetermined thickness of each individual battery electrode of the battery using a pulsed laser system that is scanned across a width based one or more measured parameters as measured by the one or more measuring devices, as in 1304. For example, first pulsed laser 120 and/or second pulsed laser 122 can removes a top surface of sample 206 to a desired thickness based on the type and/or material from which the battery electrode is composed.

The method continues by performing a removal of the portion of the top surface using a control system that is in communication with the first measurement device and the pulsed laser system or controlling the removing using a control system that is in communication with the first measurement device and the pulsed laser system, as in 1306. The performing, as in 1306, can comprise adjusting one or more laser parameters of the pulsed laser system based on measurements by the first measurement device, the second measurement device, or both, as in 1310. As shown in FIGS. 1, 2, and 8A, control system 114 is in electrical and communication connection with pulsed laser system 110 and first measurement device 102 to provide feedback to both systems and to control laser parameter adjustment of first pulsed laser 120 based on measurements made by first measurement device 120. The one or more laser parameters can comprise a focal length, a focal depth, a pulse duration, a pulse frequency, a power intensity, a spot diameter, a fluence, or combinations thereof. The one or more first parameters and the one or more second parameters can be the same or different.

The method continues by removing debris from the target region using a debris collection device, as in 1308. The debris that is removed by the debris collection device can be used for potential reuse and/or recycling. As shown in FIGS. 1 and 3, debris collection device 116, such as a cyclonic debris collector, is configured to remove the debris from laser ablation processes on the battery electrodes.

The method can also include measuring one or more second parameters of the target region of the sample of material using a second measurement device after the portion of the top surface is removed by the pulsed laser system, as in 2012. For example, as shown in FIGS. 1, 2, 3, 4, 5, 6, 7, 8A, 8B, and 8C, second measurement device 108 can measure one or more second parameters of target region 204 of sample 206. Second measurement device 108 can comprise an optical-based system, an ionizing radiation-based system, a non-ionizing radiation-based system, a weight-based system, or combinations thereof. The optical-based system can include a profilometer. Second measurement device 108 can comprise second detector 126. Second measurement device 108 can comprise a time-based device that can flash or pulse second pulsed laser 122 against a surface, such as target region 204 of sample 206, and measure the time between the flash and the reflected light reaching second detector 126. The weight-based system can measure the local weights of coatings on sample 206. The one or more first parameters can comprise a width, a surface thickness, a surface roughness, or combinations thereof, of sample 206. The surface thickness can be about 5 μm to about 1000 μm.

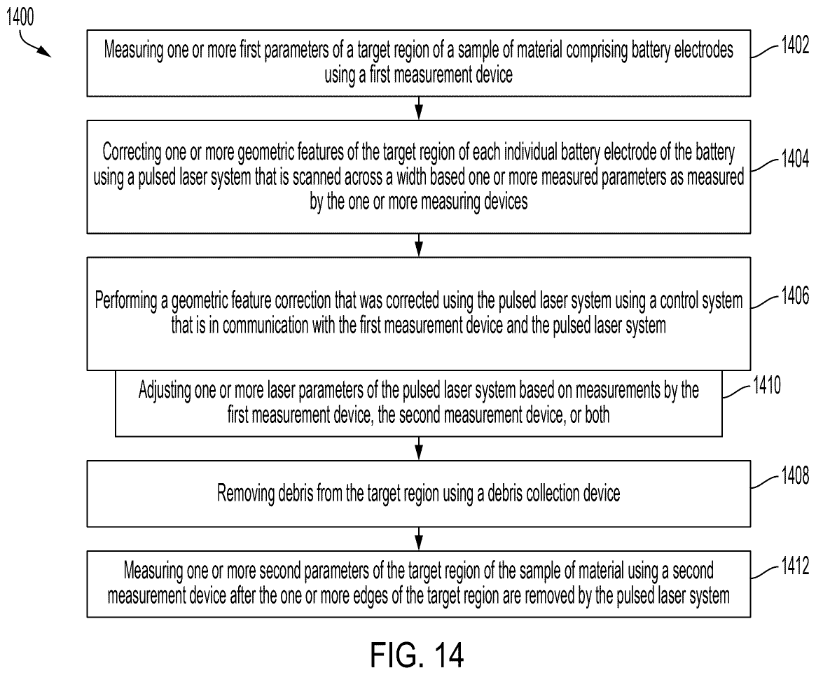

FIG. 14 shows flowchart 1400 for a method for processing battery electrodes according to examples of the present disclosure. The method beings by measuring one or more first parameters of a target region of a sample of material comprising battery electrodes using a first measurement device, as in 1402. For example, the sample with the battery electrodes can be processed on a continuous roll of material or on individual sheets of material in a batch process. For example, as shown in FIGS. 1, 2, 3, 4, 5, 6, 7, 8A, 8B, and 8C, first measurement device 102 can measure one or more first parameters of target region 204 of sample 206. First measurement device 102 can comprise an optical-based system, an ionizing radiation-based system, a non-ionizing radiation-based system, a weight-based system, or combinations thereof. The optical-based system can include a profilometer. First measurement device 102 can comprise first detector 124. First measurement device 102 can comprise a time-based device that can flash or pulse first pulsed laser 120 against a surface, such as target region 204 of sample 206, and measure the time between the flash and the reflected light reaching first detector 124. The weight-based system can measure the local weights of coatings on sample 206. The one or more first parameters can comprise a width, a surface thickness, a surface roughness, or combinations thereof, of sample 206.

The method continues by correcting one or more geometric features of the target region of each individual battery electrode of the battery using a pulsed laser system that is scanned across a width based one or more measured parameters as measured by the one or more measuring devices, as in 1404. As shown in FIGS. 2, 3, and 4, first pulsed laser 120 or second pulsed laser 122 can correct one or more geometric features of sample 206.

The method continues by performing a geometric feature correction that was corrected using the pulsed laser system using a control system that is in communication with the first measurement device and the pulsed laser system, as in 1406. The performing, as in 1406, can comprises adjusting one or more laser parameters of the pulsed laser system based on measurements by the first measurement device, the second measurement device, or both, as in 2110. As shown in FIGS. 1, 2, and 8A, control system 114 is in electrical and communication connection with pulsed laser system 110 and first measurement device 102 to provide feedback to both systems and to control laser parameter adjustment of first pulsed laser 120 based on measurements made by first measurement device 120. The one or more laser parameters comprise a focal length, a focal depth, a pulse duration, a pulse frequency, a power intensity, a spot diameter, a fluence, or combinations thereof. The one or more geometric features can comprise one or more predetermined sized and spaced apertures in the battery electrodes that can increase energy storage density, power density, or cycle life. The one or more first parameters and the one or more second parameters can be the same or different.

The method continues by removing debris from the target region using a debris collection device, as in 1408. The debris that is removed by the debris collection device can be used for potential reuse and/or recycling. As shown in FIGS. 1 and 3, debris collection device 116, such as a cyclonic debris collector, is configured to remove the debris from laser ablation processes on the battery electrodes.

The method can further comprise measuring one or more second parameters of the target region of the sample of material using a second measurement device after the correcting by the pulsed laser system, as in 1412. For example, as shown in FIGS. 1, 2, 3, 4, 5, 6, 7, 8A, 8B, and 8C, second measurement device 108 can measure one or more second parameters of target region 204 of sample 206. Second measurement device 108 can comprise an optical-based system, an ionizing radiation-based system, a non-ionizing radiation-based system, a weight-based system, or combinations thereof. The optical-based system can include a profilometer. Second measurement device 108 can comprise second detector 126. Second measurement device 108 can comprise a time-based device that can flash or pulse second pulsed laser 122 against a surface, such as target region 204 of sample 206, and measure the time between the flash and the reflected light reaching second detector 126. The weight-based system can measure the local weights of coatings on sample 206. The one or more first parameters can comprise a width, a surface thickness, a surface roughness, or combinations thereof, of sample 206. The surface thickness can be about 5 μm to about 1000 μm.

Examples of the present disclosure can be described by the following clauses.
Clause 1. A method for processing battery electrodes comprising:
   measuring one or more first parameters of a target region of a sample of material comprising battery electrodes using a first measurement device;
   removing one or more edges of the target region of each individual battery electrodes of the battery using a pulsed laser system that is scanned across a width based one or more measured parameters as measured by the one or more measuring devices;
   performing a removal of the one or more edges that were removed by the pulsed laser system using a control system that is in communication with the first measurement device and the pulsed laser system; and removing debris from the target region using a debris collection device.
Clause 2. The method of clause 1, further comprising measuring one or more second parameters of the target region of the sample of material using a second measurement device after the one or more edges of the target region are removed by the pulsed laser system.
Clause 3. The method of clause 1 or clause 2, wherein the one or more first parameters, the one or more second parameters, or both comprise a width of the sample, a surface thickness, a surface roughness, or combinations thereof.
Clause 4. The method of any of clauses 1-3, wherein the first measurement device, the second measurement device, or both comprise an optical-based system, an ionizing radiation-based system, a non-ionizing radiation-based system, a weight-based system, or combinations thereof.
Clause 5. The method of any of clauses 1-4, wherein the performing comprises adjusting one or more laser parameters of the pulsed laser system based on measurements by the first measurement device, the second measurement device, or both.
Clause 6. The method of any of clauses 1-5, wherein the one or more laser parameters comprise a focal length, a focal depth, a pulse duration, a pulse frequency, a power intensity, a spot diameter, a fluence, or combinations thereof.
Clause 7. The method of any of clauses 1-6, wherein the one or more first parameters and the one or more second parameters are the same or different.
Clause 8. A method for processing battery electrodes comprising:
   measuring one or more first parameters of a target region of a sample of material comprising battery electrodes using a first measurement device;
   removing a portion of a top surface of the target region to a predetermined thickness of each individual battery electrode of the battery using a pulsed laser system that is scanned across a width based one or more measured parameters as measured by the one or more measuring devices;
   performing a removal of the portion of the top surface using a control system that is in communication with the first measurement device and the pulsed laser system; and
removing debris from the target region using a debris collection device.
Clause 9. The method of clause 8, further comprising measuring one or more second parameters of the target region of the sample of material using a second measurement device after the portion of the top surface is removed by the pulsed laser system.
Clause 10. The method of clause 8 or clause 9, wherein the one or more first parameters, the one or more second parameters, or both comprise a width, a surface thickness, a surface roughness, or combinations thereof.
Clause 11. The method of any of clauses 8-10, wherein the surface thickness is about 5 μm to about 1000 μm.
Clause 12. The method of any of clauses 8-11, wherein the first measurement device, the second measurement device, or both comprise an optical-based system, an ionizing radiation-based system, a non-ionizing radiation-based system, a weight-based system, or combinations thereof.
Clause 13. The method of any of clauses 8-12, wherein the performing comprises adjusting one or more laser parameters of the pulsed laser system based on measurements by the first measurement device, the second measurement device, or both.
Clause 14. The method of any of clauses 8-13, wherein the one or more laser parameters comprise a focal length, a focal depth, a pulse duration, a pulse frequency, a power intensity, a spot diameter, a fluence, or combinations thereof.
Clause 15. The method of any of clauses 8-14, wherein the one or more first parameters and the one or more second parameters are the same or different.
Clause 16. A method for processing battery electrodes comprising:
   measuring one or more first parameters of a target region of a sample of material comprising battery electrodes using a first measurement device;
   correcting one or more geometric features of the target region of each individual battery electrode of the battery using a pulsed laser system that is scanned across a width based one or more measured parameters as measured by the one or more measuring devices;
   performing a geometric feature correction that was corrected using the pulsed laser system using a control system that is in communication with the first measurement device and the pulsed laser system; and
   removing debris from the target region using a debris collection device.
Clause 17. The method of clause 16, further comprising measuring one or more second parameters of the target region of the sample of material using a second measurement device after the correcting by the pulsed laser system.
Clause 18. The method of clause 16 or clause 17, wherein the one or more first parameters, the one or more second parameters, or both comprise a width of the sample, a surface thickness, a surface roughness, or combinations thereof.
Clause 19. The method of any of clauses 16-18, wherein the first measurement device, the second measurement device, or both comprise an optical-based system, an ionizing radiation-based system, a non-ionizing radiation-based system, a weight-based system, or combinations thereof.
Clause 20. The method of any of clauses 16-19, wherein the performing comprises adjusting one or more laser parameters of the pulsed laser system based on measurements by the first measurement device, the second measurement device, or both.
Clause 21. The method of any of clauses 16-20, wherein the one or more laser parameters comprise a focal length, a focal depth, a pulse duration, a pulse frequency, a power intensity, a spot diameter, a fluence, or combinations thereof.
Clause 22. The method of any of clauses 16-21, wherein the one or more geometric features comprises predetermined sized and spaced apertures in the battery electrodes that increase energy storage density, power density, or cycle life.
Clause 23. The method of any of clauses 16-22, wherein the one or more first parameters and the one or more second parameters are the same or different.
Clause 24. A system for processing battery electrodes comprising:
   a first measurement device for measuring one or more parameters of a target region of a battery electrode;
   a pulsed laser system for removing a portion of the target region of a sample of material comprising battery electrodes based one or more measured parameters as measured by the first measurement device;
   a control system for controlling the removing that is in communication with the first measurement device and the laser system; and
   a debris collection device for removing debris from the target region.
Clause 25. The system of clause 24, further comprising a second measurement device for measuring one or more second parameters of the target region after the removing by the pulsed laser system.
Clause 26. The system of clause 24 or clause 25, wherein the one or more first parameters, the one or more second parameters, or both comprise a width of the sample, a surface thickness, a surface roughness, or combinations thereof.
Clause 27. The system of any of clauses 24-26, wherein the surface thickness is about 5 μm to about 1000 μm.
Clause 28. The system of any of clauses 24-27, wherein the first measurement device, the second measurement device, or both comprise an optical-based system, an ionizing radiation-based system, a non-ionizing radiation-based system, a weight-based system, or combinations thereof.
Clause 29. The system of any of clauses 24-28, wherein the control system adjusts one or more laser parameters of the pulsed laser system based on measurements of the first measurement device, the second measurement device, or both.
Clause 30. The system of any of clauses 24-29, wherein the one or more laser parameters comprise a focal length, a focal depth, a pulse duration, a pulse frequency, a power intensity, a spot diameter, a fluence, or combinations thereof.
Clause 31. The system of any of clauses 24-30, wherein the portion of the target region comprises a current collector region that is roughened by the pulsed laser system.
Clause 32. The system of any of clauses 24-31, wherein the one or more first parameters and the one or more second parameters are the same or different.

The foregoing discussion and examples have been presented for purposes of illustration and description. The foregoing is not intended to limit the aspects, examples, or configurations to the form or forms disclosed herein. In the foregoing Detailed Description for example, various features of the aspects, examples, or configurations are grouped together in one or more examples, configurations, or aspects for the purpose of streamlining the disclosure. The features of the aspects, examples, or configurations may be combined in alternate aspects, examples, or configurations other than those discussed above. This method of disclosure is not to be interpreted as reflecting an intention that the aspects, examples, or configurations require more features than are expressly recited in each claim. Rather, as the following claims reflect, inventive aspects lie in less than all features of a single foregoing disclosed example, configuration, or aspect. While certain aspects of conventional technology have been discussed to facilitate disclosure of some examples of the present disclosure, the Applicants in no way disclaim these technical aspects, and it is contemplated that the claimed disclosure may encompass one or more of the conventional technical aspects discussed herein. Thus, the following claims are hereby incorporated into this Detailed Description, with each claim standing on its own as a separate aspect, example, or configuration.

What is claimed is:

1. A method for processing battery electrodes comprising:
measuring one or more first parameters of a target region of a sample of material comprising battery electrodes using a first measurement device;
removing one or more edges of the target region of each individual battery electrodes of a battery using a pulsed laser system that is scanned across a width based one or more measured parameters as measured by the one or more measuring devices;
performing a removal of the one or more edges that were removed by the pulsed laser system using a control system that is in communication with the first measurement device and the pulsed laser system; and
removing debris from the target region using a debris collection device.

2. The method of claim 1, further comprising measuring one or more second parameters of the target region of the sample of material using a second measurement device after the one or more edges of the target region are removed by the pulsed laser system.

3. The method of claim 2, wherein the one or more first parameters, the one or more second parameters, or both comprise a width of the sample, a surface thickness, a surface roughness, or combinations thereof.

4. The method of claim 2, wherein the first measurement device, the second measurement device, or both comprise an optical-based system, an ionizing radiation-based system, a non-ionizing radiation-based system, a weight-based system, or combinations thereof.

5. The method of claim 3, wherein the performing comprises adjusting one or more laser parameters of the pulsed laser system based on measurements by the first measurement device, the second measurement device, or both.

6. The method of claim 5, wherein the one or more laser parameters comprise a focal length, a focal depth, a pulse duration, a pulse frequency, a power intensity, a spot diameter, a fluence, or combinations thereof.

7. A method for processing battery electrodes comprising:
measuring one or more first parameters of a target region of a sample of material comprising battery electrodes using a first measurement device;
removing a portion of a top surface of the target region to a predetermined thickness of each individual battery electrode of a battery using a pulsed laser system that is scanned across a width based one or more measured parameters as measured by the one or more measuring devices;
performing a removal of the portion of the top surface using a control system that is in communication with the first measurement device and the pulsed laser system; and
removing debris from the target region using a debris collection device.

8. The method of claim 7, further comprising measuring one or more second parameters of the target region of the sample of material using a second measurement device after the portion of the top surface is removed by the pulsed laser system.

9. The method of claim 8, wherein the one or more first parameters, the one or more second parameters, or both comprise a width, a surface thickness, a surface roughness, or combinations thereof.

10. The method of claim 9, wherein the surface thickness is about 5 μm to about 1000 μm.

11. The method of claim 8, wherein the first measurement device, the second measurement device, or both comprise an optical-based system, an ionizing radiation-based system, a non-ionizing radiation-based system, a weight-based system, or combinations thereof.

12. The method of claim 8, wherein the performing comprises adjusting one or more laser parameters of the pulsed laser system based on measurements by the first measurement device, the second measurement device, or both.

13. The method of claim 12, wherein the one or more laser parameters comprise a focal length, a focal depth, a pulse duration, a pulse frequency, a power intensity, a spot diameter, a fluence, or combinations thereof.

14. A method for processing battery electrodes comprising:
measuring one or more first parameters of a target region of a sample of material comprising battery electrodes using a first measurement device;
correcting one or more geometric features of the target region of each individual battery electrode of a battery using a pulsed laser system that is scanned across a width based one or more measured parameters as measured by the one or more measuring devices;
performing a geometric feature correction that was corrected using the pulsed laser system using a control system that is in communication with the first measurement device and the pulsed laser system; and
removing debris from the target region using a debris collection device.

15. The method of claim 14, further comprising measuring one or more second parameters of the target region of the sample of material using a second measurement device after the correcting by the pulsed laser system.

16. The method of claim 15, wherein the one or more first parameters, the one or more second parameters, or both comprise a width of the sample, a surface thickness, a surface roughness, or combinations thereof.

17. The method of claim 15, wherein the first measurement device, the second measurement device, or both comprise an optical-based system, an ionizing radiation-based system, a non-ionizing radiation-based system, a weight-based system, or combinations thereof.

18. The method of claim 15, wherein the performing comprises adjusting one or more laser parameters of the pulsed laser system based on measurements by the first measurement device, the second measurement device, or both.

19. The method of claim 18, wherein the one or more laser parameters comprise a focal length, a focal depth, a pulse duration, a pulse frequency, a power intensity, a spot diameter, a fluence, or combinations thereof.

20. The method of claim 14, wherein the one or more geometric features comprises predetermined sized and spaced apertures in the battery electrodes that increase energy storage density, power density, or cycle life.
